(19) United States
(12) Patent Application Publication
(10) Pub. No.: US 2003/0158781 A1
(43) Pub. Date: Aug. 21, 2003

(54) Credit card substitute system

(76) Inventor: Varughese Philip, Roslyn, NY (US)

Correspondence Address: VARUGHESE PHILIP, 192 DOGWOOD ROAD, ROSLYN, NY, 11576, US

(21) Appl. No.: 10/076,263

(22) Filed: Feb. 15, 2002

(51) Int. Cl. G06F 17/60

(52) U.S. Cl. 705/16

(57) ABSTRACT

A credit card number is assigned to a transponder as its tag number. The transponder has a circuit for wirelessly transmitting the tag number to a reader located at any point of sale. The reader is connected to a credit card company database. The transponder has also a keypad for a user to program a personal identification number. When a card member enters in to a transaction with a merchant, the card member will simply point the transponder at a reader and enter a personal identification number on the transponder and an authorization is returned from the credit card company.

### FIELD OF THE INVENTION

This invention relates to a system and method of assigning a credit card number to a transponder as its tag number so as to use the transponder in place of plastic credit card during a credit card transaction.

### BACKGROUND OF THE INVENTION

Today's credit cards and debit cards are in the form of plastic cards with a magnetic strip attached to the card and other information printed on the card. One usually has to carry the card in a wallet or purse and use the card to make a credit card transaction. Plastic cards can easily bend and magnetically stored information can be lost.

Additionally, more and more consumers are using self check out counters where consumers can ring up their own merchandise and pay with a credit card without a cashier's intervention. In such cases, use of a stolen credit card cannot be checked because a cashier is not involved and unauthorized charges can be discovered on the account. The use of Radio Frequency Technology for recognizing items by means of RF tags has been well known. Even though transponders are used for payments at toll collecting systems and other businesses, transponders have never been used as a substitute for the credit card with a credit card number assigned to the transponder as its tag number. The transponders are interrogated by signals produced by readers/receivers which respond to those signals by transmitting a unique “tag number” identifying the transponder. It would be an advantage, therefore, to use transponder as a substitute for the plastic credit card. The system can be utilized to operate ATM (automated teller machines) using transponder as a substitute for the plastic ATM cards.

### SUMMARY OF THE INVENTION

It is therefore an object of the present invention to overcome the drawbacks of existing credit cards.

It is another object of the present invention to provide a substitute for the plastic card used today as a credit card.

A further object of the present invention is a system and method for enabling a card holder to use transponder in place of credit card during a credit card transaction. This is accomplished by assigning a credit card number to a transponder as its tag number and providing the customer with a transponder in place of the plastic card. The transponder also has a keypad for a user to program a personal identification number. The transponder has an advantage over plastic cards because plastic cards cannot be programmed by the user with a personal identifiaction number. By using a transponder that can be programmed by the user with a personal identification number, unauthorized charges on the credit card can be greatly reduced.

### BRIEF DESCRIPTION OF THE DRAWINGS

FIG. 1. is a flowchart depicting the transaction between a card member and merchant in accordance with the present invention.

FIG. 2. is a flowchart depicting the registration and activation process for a new card member in accordance with the present invention.

FIG. 3. is a flowchart depicting the assignment and activation process for a current card member in accordance with the present invention.

### DETAILED DESCRIPTION OF THE PREFERRED EMBODIMENTS

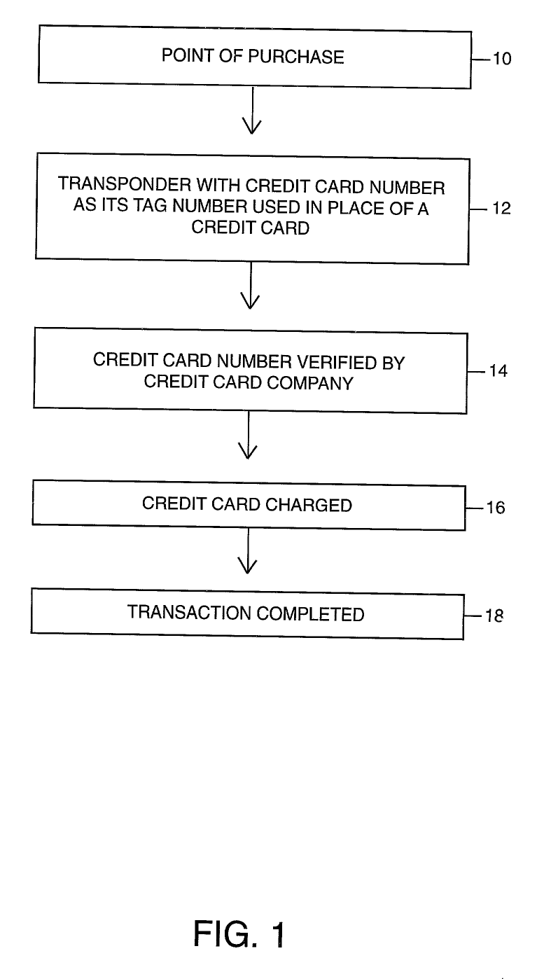

FIG. 1 Shows a cardholder transaction according to the present invention. In FIG. 1, customer makes a credit card purchase at a point of purchase, step 10. (Any place that accepts a credit card would be a point of purchase.) Instead of providing the merchant with a credit card for payment, the card member uses a transponder with the credit card number assigned to the transponder as its tag number. The card member will simply point the transponder at a reader similar to the credit card readers in use today and enter a personal identification number on the transponder, step 12. The reader is connected to the database maintained by the credit card company. The credit card number is then verified by the credit card company, step 14. After validation process, the credit card will be charged and the merchant will be notified of the validation, step 16. The card member then has to sign a receipt and the transaction is completed, step 18.

The process is similar to the current day credit card transaction with the exception that a transponder with a credit card number assigned to transponder as its tag number is used instead of the plastic card.

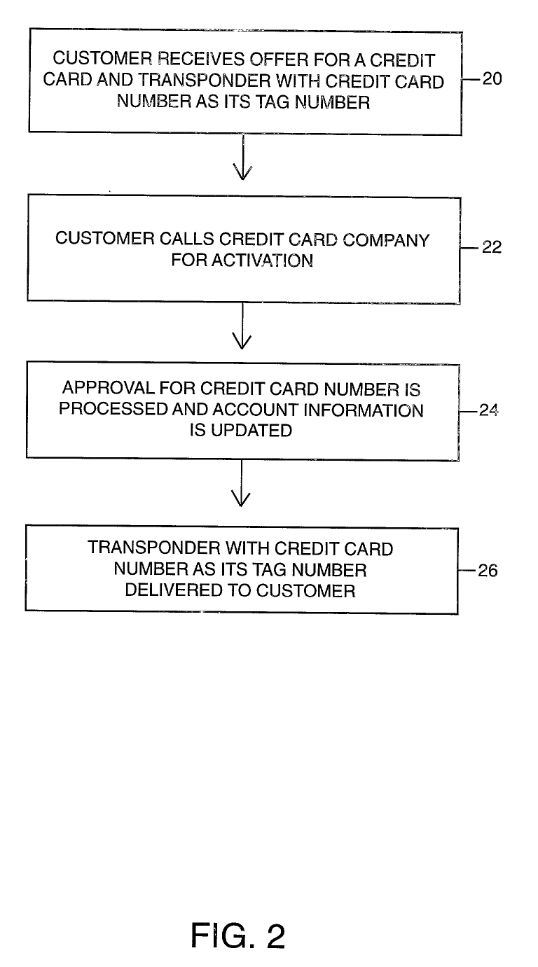

FIG. 2 Shows registration and activation process for a new card member. A new member would receive a credit card offer with an option to assign the credit card number to a transponder as its tag number and use the transponder in place of the plastic card, step 20. The customer can accept the offer and apply for the credit card and transponder by calling a designated number, step 22. Approval for the new account is processed and account information is updated, step 24. After activation process transponder with credit card number as its tag number is delivered to the card member, step 26.

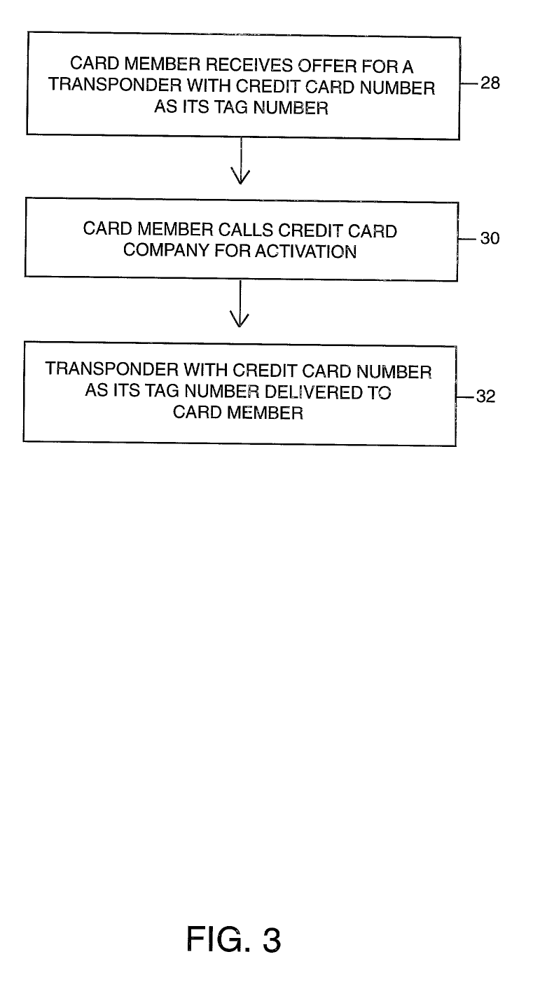

FIG. 3 Shows assignment and activation process for a current card member. A current card member is a person that has a credit card account with a credit card company. The card member receives offer for a transponder with the credit card number as its tag number, step 28. The card member responds to the offer by calling the credit card company, step 30. Transponder with credit card number as its tag number is delivered to the card member, step 32.

Security measures for the credit card substitute system will be much the same as those used by credit cards. Credit cards in general are not secure and a lost or stolen credit card can be misused. The same systems used to handle fraud for credit cards will be used to handle the present invention. By using a transponder that can be programmed by the user with a personal identification number, unauthorized charges on the credit card can be greatly reduced even if the transponder is lost or stolen.

What is claimed is:

1. A method for completing a credit card transaction in which a credit card holder uses a transponder in place of the plastic card during a credit card transaction, the method comprising the steps of:
assigning a credit card number to a transponder as its tag number;
using the transponder in place of the credit card;
providing a credit card owner with the transponder;
retrieving the credit card number from the database maintained by the credit card company using the transponder;
authenticating the transaction after verifying the credit card number through database search; and
informing the merchant of the authentication and charging of the credit card.

2. The method of claim 1, wherein the said transponder has a keypad.

3. The method of claim 1, wherein the said transponder can be programmed with a personal identification number.

4. A method for completing a credit card transaction in which a credit card holder uses a transponder in place of the plastic card during a credit card transaction, the method comprising the steps of:
initiating a transaction when a card holder points the transponder at a reader and enters a personal identification number on the transponder;
wirelessly transmitting the credit card number to the reader;
searching the database for the credit card number;
authenticating the transaction after verifying the credit card number through database search; and
completing the transaction by charging the credit card.
